(19) United States
(12) Patent Application Publication
(10) Pub. No.: US 2016/0221497 A1
(43) Pub. Date: Aug. 4, 2016

(54) ASSEMBLY FOR ACTUATING A VEHICLE FUNCTION

(71) Applicant: HUF HÜLSBECK & FÜRST GMBH & CO. KG, Velbert (DE)

(72) Inventors: Mirko Schindler, Velbert (DE); Peter Van Gastel, Solingen (DE); Bernd Gerdes, Essen (DE)

(73) Assignee: Huf Huelsbeck & Fuerst GmbH & Co. KG, Velbert (DE)

(21) Appl. No.: 15/021,574

(22) PCT Filed: Aug. 5, 2014
(86) PCT No.: PCT/EP2014/066828

§ 371 Date: Mar. 11, 2016

(30) Foreign Application Priority Data
Sep. 25, 2013 (DE) 10 2013 110 596.3

(51) Int. Cl. B60Q 1/56; B60R 13/00

(52) U.S. Cl. CPC B60Q 1/56; B60R 13/005

(57) ABSTRACT

An assembly for actuating a vehicle function includes a cover element which is at least in part designed as a vehicle emblem, a light distribution device disposed beneath the cover element and a light source that is disposed beneath the light distribution device. The light source and the light distribution device are adapted for backlighting the cover element. A printed circuit board with a proximity sensor is disposed beneath the light distribution device. The proximity sensor is designed and configured for detecting proximity to the cover element. A control and evaluation circuit is coupled to the light source and the proximity sensor in order to switch on the light source as a function of proximity.

The invention relates to an assembly for use on a motor vehicle. In particular, the invention relates to an assembly that is disposed on a motor vehicle in order to enable an actuation of a vehicle function.

Numerous assemblies for vehicles are known in the prior art that serve for the different functions.

An assembly is known for example from EP 2 067 665 A1. Therein, a manufacturer emblem or manufacturer logo is attached to a vehicle, and is backlit using a light source and a waveguide device.

Another backlit vehicle logo is known from DE 102004 024 263 A1.

The aforementioned illuminated vehicle emblems serve exclusively to improve the design and to increase the appearance value of a vehicle thereby. They do not, however, fulfill a functional aspect.

The object of the invention is to create a multifunctional assembly for vehicles.

This object is achieved according to the invention by an assembly having the features of Claim 1.

According to the invention, a vehicle emblem (or manufacturer emblem) is combined with a proximity sensor system in order to create an assembly for actuating a vehicle function.

For this, the assembly according to the invention has an upper cover element facing the user, which in part is designed as a vehicle emblem. When a vehicle emblem is referred to herein, this can be any arbitrary decorative or trademark element that is intended to provide an optical value enhancement or identification of the vehicle. A light distribution device is disposed in accordance with the invention beneath this cover element. A light source, in turn, is disposed beneath or inside the light distribution device, such that when the effects of the light source and the light distribution device are combined, a backlighting of the cover element disposed thereon is obtained.

Schematically, the construction up to this point is comparable with the prior art specified above, in particular EP 2 067 665 A1. Therein, a wave guide having waveguide surfaces or light deflection surfaces is used as a light distribution device according to the invention. Another type of light distribution device, e.g. multi-wired light distribution device or even a diffuser, may be used, for example.

In accordance with the invention, however, the function of the assembly is not exhausted with the backlighting of a decorative element, but rather, it serves for the sensing of function actuations. For this, a printed circuit board with a proximity sensor is disposed beneath the light distribution device, wherein the proximity sensor is designed and configured to detect proximities to the cover element that can be backlit. The proximity sensor thus detects a proximity of an object to the cover element through the light distribution device and the cover element. The sensor is located on the side of the cover element facing the user, the user thus sees the illuminated cover element, and can locate the surface sensed accordingly without difficulty in this manner. In particular, manufacturer emblems or vehicle emblems are frequently located at prominent places on the vehicle, such that a location of these emblems is not difficult. This is a further advantage of the invention, because the actuation element simultaneously acts as a design element, and for this reason, is to be disposed at easily accessible locations on the vehicle. Operating elements are often disposed in the prior art at discreet, but difficult to access, locations, because they could detract from the appearance of a vehicle. Furthermore, with the invention, the cover element protect the proximity sensor for environmental effects.

A control and evaluation circuit is coupled to the light source and the proximity sensor, which can be disposed directly on the printed circuit board, but can likewise be placed at another position in the assembly. This control and evaluation circuit controls the proximity sensor in the manner intended, technologically. Both capacitive as well as inductive proximity sensors may be used. Both types are available in the market, and provided with appropriate wiring instructions. Capacitive sensors may furthermore be designed with metal surfaces, which are coupled to a suitable charging electronics. The detection range of the sensor extends through the components oriented toward the user in front of this, and detects, without contact, the proximity of a user.

Depending on the detection of the proximity, it is possible for the control and evaluation device to activate the light source. This activation may occur in a variety of ways. By way of example, the light may be used to direct a user for a use. The color of the light source can also be changed, in order to indicate an operating state of the device. By way of example, the vehicle emblem can be backlit with a first color when the vehicle, or a hatch, which is to be opened by means of the actuation device, is in the locked state. The color can then be changed depending on the locking state. Furthermore, the lighting device can be activated in order to confirm the proximity of the user or actuation. Lastly, the lighting device can also be used in order to indicate a correct operation to the user. If, for example, the user approaches the actuation device, or even touches it, this can be regarded as a first part of an actuation procedure. The control and evaluation device detects this proximity, and the remaining of the user in the proximal position. The user leaves, for example, a hand at a few centimeters away from the actuation device, or places it for a few seconds on the cover element. If the user then desires to activate the vehicle function, he is then requested, by means of a light signal initiated by the control and evaluation device, to remove the hand within a specific time period, or to execute some other gesture, such as a removal and replacement of the hand thereon. If the user fulfills this requirement, the vehicle function is then triggered.

The assembly according to the invention thus provides a novel combination of an optical identification and an actuation. The assembly may be used for aesthetic purposes, but also fulfills, however, the technical purposes, in particular, in combination with a proximity sensor disposed therein. The proximity sensor, in turn, combined with the lighting function, enables a particularly reliable and user-friendly access. Because it is located in a region on the vehicle where a vehicle emblem is normally placed for identification of the vehicle, this device can also be disposed on the vehicle such that it is advantageously accessible. The aesthetic effect is thus the key, or justification, for a particularly convenient arrangement on the vehicle, and opens up entirely new operating possibilities.

The important thing thereby is that the proximity sensors enable a detection without direct contact, and therefore also enables a spatial monitoring, through the components placed in front thereof.

In a preferred design of the invention, the cover element has a partially transparent front surface, and the light distribution device is designed for illuminating the translucent region of the cover element.

Fundamentally, the cover element can be entirely opaque, i.e. not translucent. The light distribution device then backlights the cover element such that light is emitted along the periphery of the cover element, such that this contour line stands out against its surroundings. The cover element can, however, particularly preferably, have translucent regions, in order to enable an even better visual perception of the cover element and the assembly with its actuation function.

In a further development of the invention, sub-regions of the front surface are metal plated, e.g. chrome plated, or designed with a metal coating. The cover element can, for example, be formed from transparent or opaque plastics, which are partially provided with a chrome plating. The cover element can also be composed of numerous parts. By way of example, it is possible to provide the cover element with a chrome-plated emblem, which is disposed on a transparent or translucent backing. The cover element is then formed by the combination of the backing with the emblem attached thereto. The metal-plated regions could affect the detection behavior of the proximity sensor thereby. In particular when capacitive sensors are used as proximity sensors, metal-plated parts of the cover element act as capacitor surfaces. This effect is, however, entirely calculated, and even desired to a certain extent, in order to reliably detect the actuation. Furthermore, the use of capacitive sensors is an established prior art in the actuation of vehicle functions. There is a broad knowledge of use of these sensors, in the field of keyless entry systems, for example, in which vehicle door handles detect the proximity of a user.

The light distribution device can have a variety of designs, e.g. a simple plastic disk, into which light from a light source (e.g. an LED) is conducted.

The light distribution can also take place such that light is conducted to discreet positions by passing through the cover device, by means of single, or bundles of, waveguide fibers. Furthermore, flat waveguide devices may be formed, designed as diffusors or waveguide disks, for example, having a geometric design, with which light is emitted along lines or surfaces.

In a further development of the invention, the assembly is designed with an additional switching function, which can also be designed as a redundant switching function. In this design, the cover element can be moved against the printed circuit board. The cover element is spring-supported, and spaced apart from the printed circuit board and a switch disposed thereon, in particular a micro-switch, when in the standby position. The cover element with the emblem can, as a whole, be actuated against the printed circuit board and a spring force, in order to execute a spring-loaded switch function. Accordingly, the printed circuit board thus has a proximity sensor as well as a contact switch. The contact switch is actuated when the cover element is pressed. The design and construction of such an assembly can be easily implemented mechanically, because the cover element itself has no electronic or electrical components. It is merely a decorative, covering, actuation plate, by means of which both a proximity of a user is detected by the proximity sensors, and an actuation by pressing the actuation element, is enabled. In this manner, both redundant switching functions, i.e. uniform function triggering through proximity or actuation, as well as different operating concepts, are possible. The switch can thus be assigned the same functions as the proximity detection, but on the other hand, proximity evaluations can also be assigned other actuation functions than the actuation of the switch.

The invention shall now be explained in greater detail based on the attached drawings.

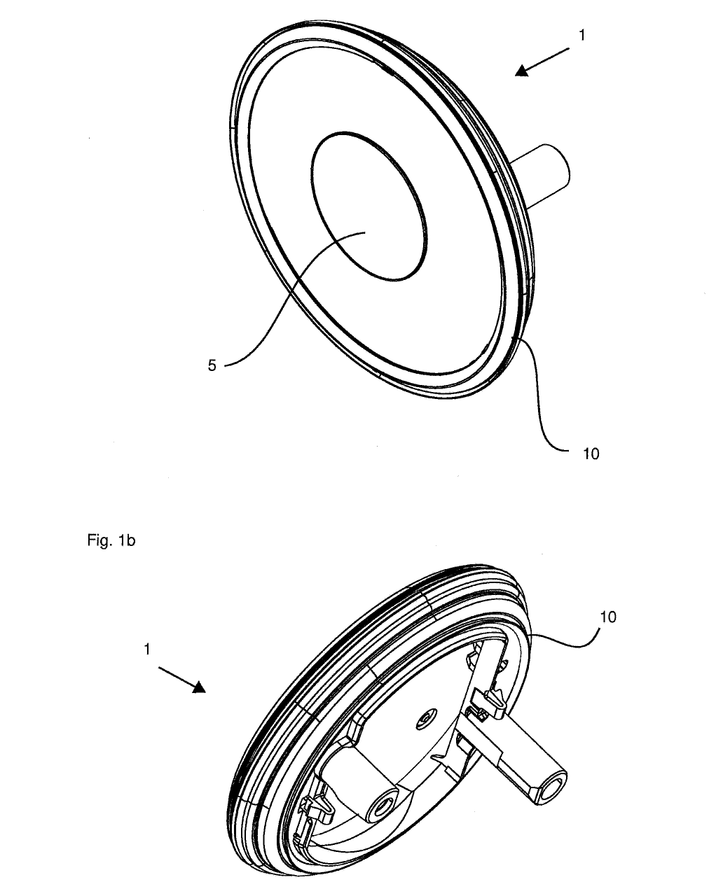

FIG. 1a shows a first embodiment of the invention in a perspective, diagonal front view.

FIG. 1b shows the embodiment from FIG. 1a in a perspective, diagonal rear view.

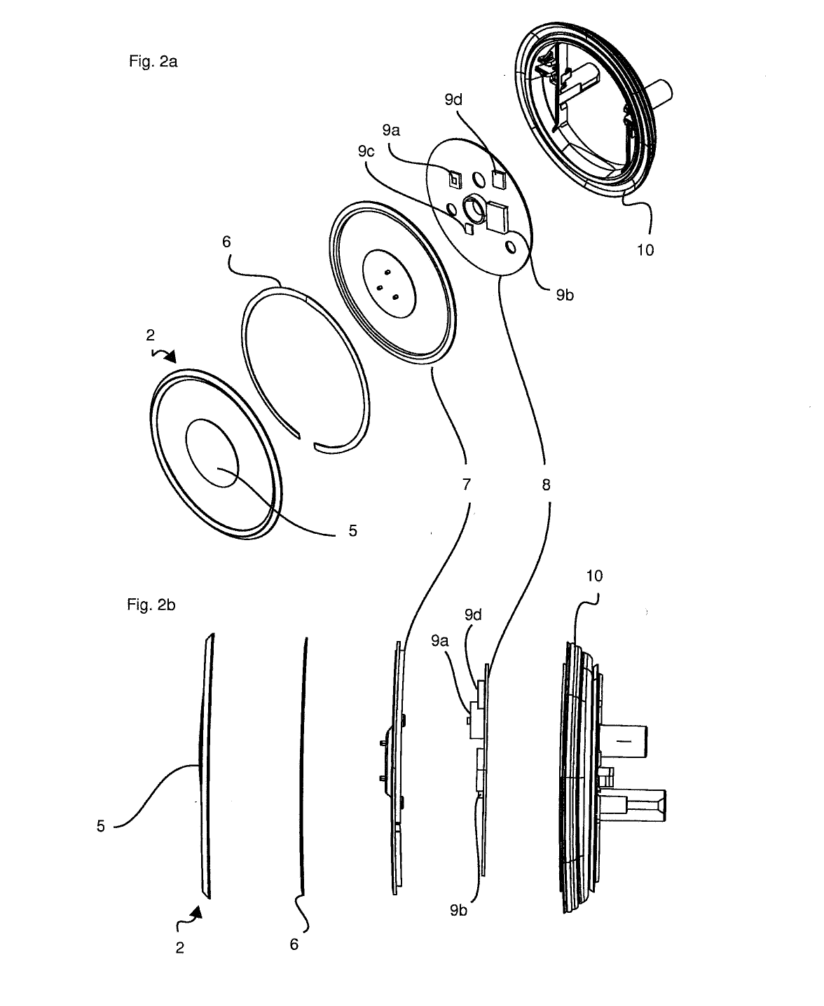

FIG. 2a shows a first exploded view of the first embodiment.

FIG. 2b shows a second exploded view of the first embodiment.

FIGS. 1a and 1b show the assembly 1 according to the invention in the installed state. The assembly depicted in this manner can be installed in a recess on the vehicle body, e.g. on the rear hatch of a vehicle. In this embodiment, the vehicle emblem is designed in a stylized manner as a central circular emblem 5.

A plate-like housing 10 encases the various components of the assembly according to the invention, and offers mounting possibilities on the rear surface, in particular clips and holes for wires, in particular for signal lines and power lines for the control and evaluation circuit, as well as the proximity sensors and the light source.

The depicted assembly according to the invention is compact, and comprises the functions of proximity detection, illumination of the vehicle emblem, and a spring-loaded switch.

FIGS. 2a and 2b show, in respective exploded views, the construction of the device according to the invention.

There is a cover element 2, facing the user, which has a round, transparent cover in this example, having a chrome-plated circular emblem 5 in the middle. In other designs, more complex manufacturer emblems may be used, but for an explanation of the invention, a simple element is sufficient. The cover element 2 is secured to the waveguide element with an annular adhesive element 6, provided with adhesive on both sides. The waveguide element 7 has a similar design to that of the cover element 2 itself, but is made from a waveguide material having appropriate shapes for ensuring a backlighting of the central element 5. For this, the waveguide element 7 has a raised light emission surface in the central region, which corresponds, in terms of its contour, to the vehicle emblem 5. Additional light exit points are defined in this region, which provide for an additional backlighting of the chrome element 5. Furthermore, a roughened surface of the light guidance element is formed along an annular region, the region that is not covered by the chrome-plated part of the emblem 5, in order to ensure a diffused illumination of this region of the cover surface. A printed circuit board 8 is disposed behind the waveguide element 7. This printed circuit board is supported by the housing structure 10, which is described above, with reference to FIGS. 1a and 1b. The housing 10 serves to anchor the assembly on the vehicle, and to securely accommodate the printed circuit board. Furthermore, the housing structure is secured on the vehicle, and the cover element 2, which is glued onto the waveguide element 7, can be moved against the housing structure, and thus against the printed circuit board 8, counter to a spring tension. The spring elements are not shown in this design for purposes of clarity.

Both a capacitive sensor 9b, as well as a surface mounted LED 9c, which lights the light deflection element 7, are disposed on the printed circuit board 8. Furthermore, a micro-switch 9a is disposed on the printed circuit board, which registers a pressing actuation, when the components of the cover plate 2, with the waveguide 7, move against the printed circuit board 8, and trigger the spring-loaded switch 9a, designed as a micro-switch. A control and evaluation device 9d is coupled to the components 9a, 9b, and 9c.

The depicted exemplary embodiment thus provides an actuation device, which backlights a vehicle emblem or vehicle logo (or manufacturer logo), and offers the user a readily locatable and easy to actuate device. The user can execute both a push-button actuation, as well as a proximity actuation, registered by the proximity sensor 9b. The control and evaluation device 9a activates the light source 9c, as a function of the actuations. The light source 9c can thus be activated as a function of the mechanical actuation, detected by the spring-loaded switch 9a, and also by the proximity detection by the sensor 9b. Furthermore, the control and evaluation circuit 9d can provide feedback to the user via the light source 9c, in order to provide him with instructions for following a specific usage procedure. Thus, the user may be instructed to execute, for example, an actuation, in the form of advancing or removing a body part within a time period, which is made visible by a light signal.

Fundamentally, other components can also be accommodated in the actuation device 1. The important thing, however, is that a cover device with an emblem is provided, and the cover device can be backlit with a light distribution device, wherein the illumination is activated by a control and evaluation device. The combination with a proximity sensor then offers the advantages, specified above, of an integrated actuation device with a user-friendly actuation possibility.

1. An assembly for actuating a vehicle function, comprising a cover element, which is at least in part designed as a vehicle emblem, a light distribution device disposed beneath the cover element, and a light source disposed beneath the light distribution device, wherein the light source and the light distribution device are disposed for backlighting the cover element, wherein a printed circuit board with a proximity sensor is disposed beneath the light distribution device, wherein the proximity sensor is designed and configured for detecting proximities to the cover element, and wherein a control and evaluation circuit is coupled to the light source and the proximity sensor, in order to switch on the light source as a function of a proximity.

2. The assembly according to claim 1, wherein the cover element has a partially translucent front surface, and wherein the light distribution device is designed to illuminate the translucent regions of the cover element.

3. The assembly according to claim 2, wherein the front surface is at least partially metal-plated.

4. The assembly according to claim 1, wherein the light distribution device has waveguide regions for conducting and deflecting light from the light source.

5. The assembly according to claim 1, wherein the light distribution device has diffusion regions for scattering light from the light source.

6. The assembly according to claim 1, wherein the proximity sensor is designed as a capacitive sensor.

7. The assembly according to claim 1, wherein a switch is disposed beneath the cover element, on the printed circuit board, and the cover element is disposed such that it can move in relation to the switch, such that a switch actuation occurs as a result of the mechanical action applied to the cover element.

8. The assembly according to claim 3 wherein the front surface is chrome-plated.
